(19) United States
(12) Patent Application Publication
(10) Pub. No.: US 2017/0054127 A1
(43) Pub. Date: Feb. 23, 2017

(54) SECONDARY BATTERY AND FABRICATING METHOD THEREOF

(71) Applicant: SAMSUNG SDI CO., LTD., Yongin-si (KR)

(72) Inventor: Hoseong KIM, Yongin-si (KR)

(21) Appl. No.: 15/225,857

(22) Filed: Aug. 2, 2016

(30) Foreign Application Priority Data
Aug. 20, 2015 (KR) 10-2015-0117246

(51) Int. Cl. H01M 2/26; H01M 2/16; H01M 4/133; H01M 10/04; H01M 4/66; H01M 4/131; H01M 4/525; H01M 2/08; H01M 4/587

(52) U.S. Cl. CPC H01M 2/26; H01M 2/08; H01M 2/1653; H01M 4/133; H01M 4/587; H01M 4/661; H01M 4/131; H01M 4/525; H01M 10/0468

(57) ABSTRACT

A secondary battery including an electrode assembly, which increases a capacity by increasing areas of electrode plates, and a fabricating method thereof are provided. The secondary battery including an electrode assembly, the electrode assembly includes at least one first electrode plate having a first polarity, at least one separator surrounding the at least one first electrode plate, and at least one second electrode plate stacked with respect to the first electrode plate and the separator.

### CROSS-REFERENCE TO RELATED APPLICATION

Korean Patent Application No. 10-2015-0117246, filed on Aug. 20, 2015, in the Korean Intellectual Property Office, and entitled: “Secondary Battery and Fabricating Method Thereof,” is incorporated by reference herein in its entirety.

### BACKGROUND

1. Field

Embodiments of a secondary battery including an electrode assembly and a fabricating method thereof.

2. Description of the Related Art

Technological development and increased demand for mobile devices have led to a rapid increase in the demand for secondary batteries as energy sources. Among these secondary batteries, lithium secondary batteries, having high energy density and voltage, long life span, and low self-discharge, are commercially available and widely used.

Lithium secondary batteries may be classified into lithium ion batteries, lithium ion polymer batteries, lithium polymer batteries, and the like, according to structural features of electrode and electrolyte used. Lithium ion polymer batteries, which have various advantages, including little probability of electrolyte leakage, reduced weights and manufacturing costs, diversity of shapes, and so on, are particularly widely used.

An assembly of a secondary battery including a positive electrode, a separator, and a negative electrode may be largely classified into a jelly-roll type (winding type) and a stack type. The jelly-roll type electrode assembly may be manufactured by coating an electrode active material on a metal foil used as a current collector, drying, pressing, cutting in the form of a band having a desired width and length, separating the positive electrode and the negative electrode using the separator, and spirally winding the resultant structure.

The stack type electrode assembly is constructed such that a plurality of positive and negative electrode units are sequentially stacked.

### SUMMARY

According to an aspect of the exemplary embodiments, there is provided a secondary battery including an electrode assembly, wherein the electrode assembly includes at least one first electrode plate having a first polarity; at least one separator surrounding the at least one first electrode plate; and at least one second electrode plate stacked with respect to the first electrode plate and the separator.

The first electrode plate may be formed such that front and rear surfaces coated with active materials are wrapped by the separator.

The separator may be fused along edges in a state in which the separator is folded with the first electrode plate interposed therebetween.

The first electrode plate may be sealed by the separator.

The separators may seal the first electrode plate, except for the first lead tab coupled to the first electrode plate.

The electrode assembly may, in a state in which the first electrode plate, the separators and the second electrode plate are stacked, further include a sealing tape surrounding outer peripheral edges of the electrode assembly.

The secondary battery may further include at least one first lead tab coupled to the first electrode plate and at least one second lead tab coupled to the second electrode plate, wherein each of the at least one first lead tab is formed at a same first lead tab position and each of the at least one second lead tab is formed at a same second lead tab position to overlap each other.

The first lead tab and the second lead tab may be formed to be spaced apart from each other in a direction perpendicular to a direction in which the first electrode plate and the second electrode plate are stacked.

According to another aspect of the exemplary embodiments, there is provided a fabricating method of a secondary battery including an electrode assembly, the fabricating method including placing a first electrode plate at a boundary region corresponding to a central portion of a separator and folding the separator around the boundary region, fusing edges of the separator by thermal compression and sealing the first electrode plate, and stacking a second electrode plate so as to correspond to the first electrode plate and the separator.

The fabricating method may further include stacking the first electrode plate, the separators and the second electrode plate, and then applying a sealing tape surrounding outer peripheral edges of the electrode assembly.

### BRIEF DESCRIPTION OF THE DRAWINGS

Features will become apparent to those of ordinary skill in the art by describing in detail exemplary embodiments with reference to the attached drawings in which:

FIG. 1 illustrates an exploded perspective view illustrating a secondary battery according to an embodiment;

FIG. 2 illustrates a sectional view illustrating an electrode assembly in the secondary battery shown in FIG. 1;

FIG. 3 illustrates a first electrode plate and a separator coupled to each other in the electrode assembly in the secondary battery shown in FIG. 1;

FIG. 4 illustrates a front view illustrating a positional relationship between a first electrode plate and a second electrode plate in the electrode assembly in the secondary battery shown in FIG. 1;

FIG. 5 illustrates an exploded perspective view illustrating a secondary battery according to another embodiment; and

FIG. 6 illustrates a flowchart for explaining a fabricating method of a secondary battery according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

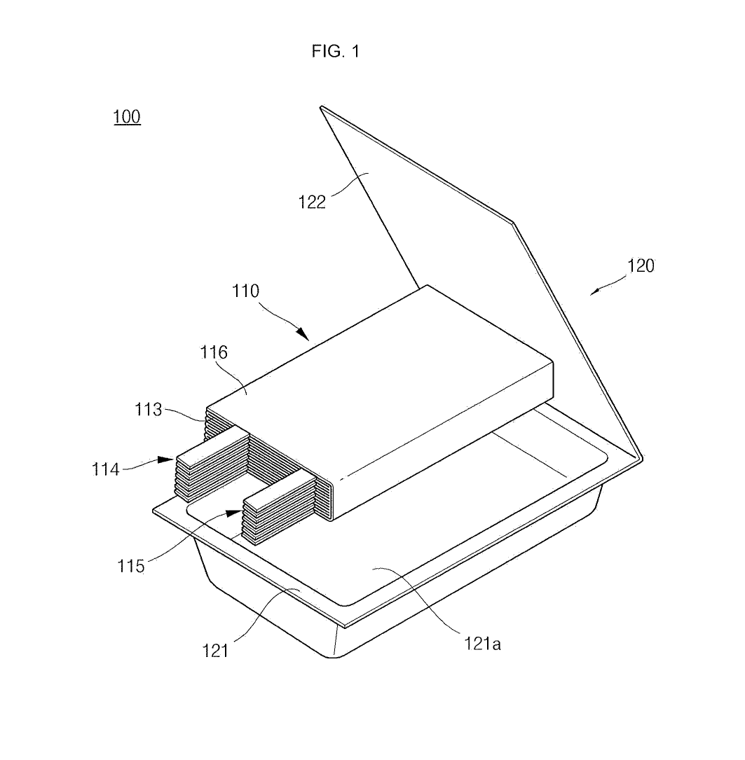

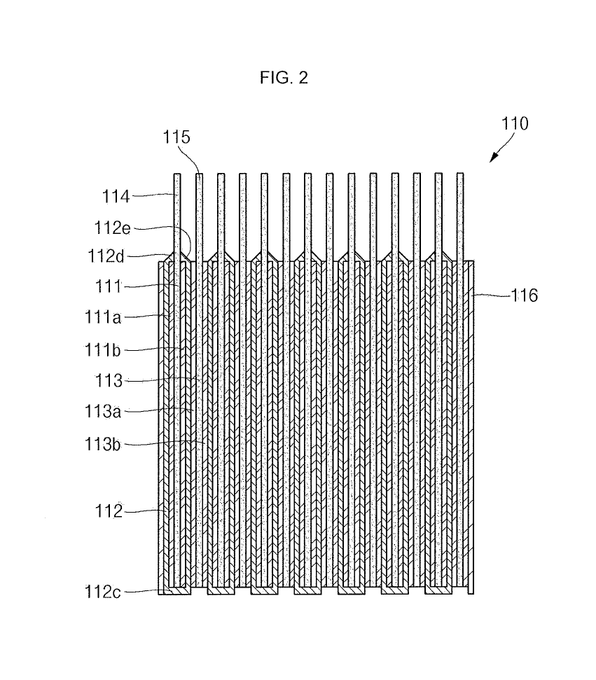

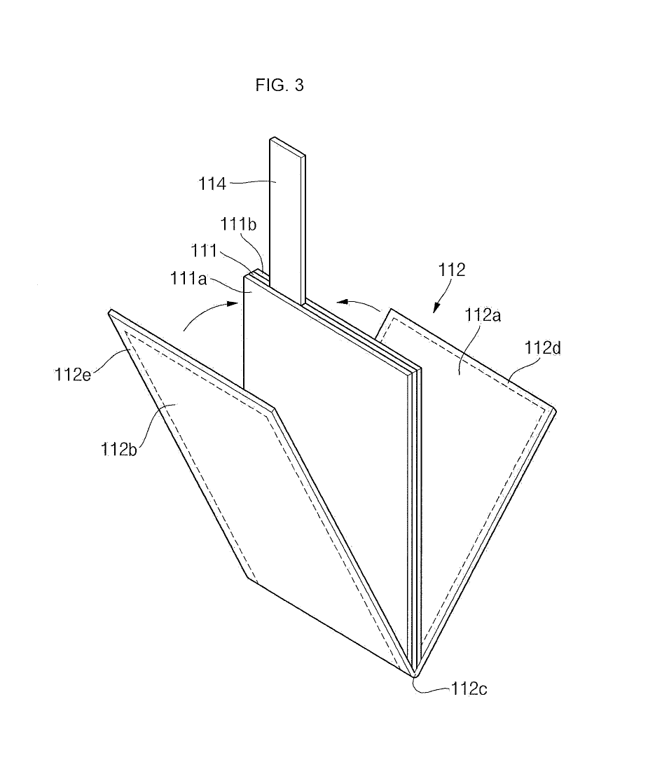

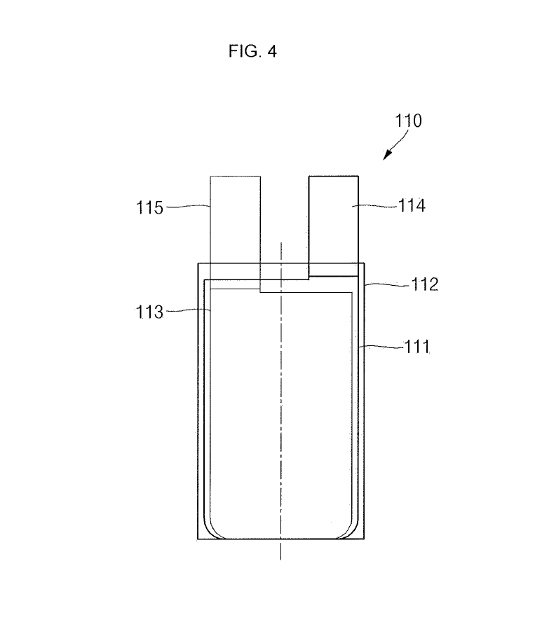

FIG. 1 is an exploded perspective view illustrating a secondary battery according to an exemplary embodiment, FIG. 2 is a sectional view illustrating an electrode assembly in the secondary battery shown in FIG. 1, FIG. 3 illustrates a first electrode plate and a separator coupled to each other in the electrode assembly in the secondary battery shown in FIG. 1, and FIG. 4 is a front view illustrating a positional relationship between a first electrode plate and a second electrode plate in the electrode assembly in the secondary battery shown in FIG. 1.

Referring to FIGS. 1 to 4, the secondary battery 100 according to an exemplary embodiment includes an electrode assembly 110 and a pouch 120 accommodating the electrode assembly 110.

The electrode assembly 110 includes a first electrode plate 111, a separator 112 and a second electrode plate 113, stacked in multiple units. In addition, the electrode assembly 110 may include a first lead tab 114 coupled to the first electrode plate 111, a second lead tab 115 coupled to the second electrode plate 112 and a sealing tape 116 surrounding outer peripheral edges of the electrode assembly 110 in a state in which the first and second electrode plates 111 and 113 are stacked.

In more detail, the electrode assembly 110 may be configured such that each of a plurality of first electrode plates 111 is wrapped by the separator 112 to then be coupled to the separator 112 and the second electrode plate 113 is then stacked thereon.

The first electrode plate 111 may include a plurality of first electrode plates 111, e.g., negative electrode plates. The following description will be made with regard to a case where the first electrode plate 111 is a negative electrode plate. The first electrode plate 111 may be formed by coating a first active material layer 111a, 111b, including a negative electrode active material, on a negative electrode current collector made of a metal foil to a predetermined thickness. That is to say, the first electrode plate 111 may be formed by binding the first active material layer 111a, 111b, including, for example, graphite, to a copper foil. However, the exemplary embodiments do not limit the materials of the first electrode plate 111 to that listed herein. In addition, first non-coating portions, where the first active material layers 111a and 111b are not coated, are formed on opposite surfaces of the first electrode plate 111.

Meanwhile, the opposite surfaces of the first electrode plate 111 are covered by the separator 112. In more detail, each of the first electrode plates 111 is individually packaged by the separator 112. The separator 112 covers the remaining region of the first electrode plate 111, except for a region from which the first lead tab 114 protrudes, thereby electrically separating the first electrode plate 111 from the second electrode plate 113 and the pouch 120. Therefore, it is possible to prevent an occurrence of an electrical short of the secondary battery caused by the first electrode plate 111. In addition, since the first electrode plates 111 are individually wrapped by the separator 112 as a whole, it is possible to prevent the first electrode plate 111 from moving in the separator 112. Therefore, when the second electrode plates 113 are stacked, alignment margin of the second electrode plates 113 can be minimized to avoid movement of the first electrode plate 111. Consequently, it is possible to increase the battery capacity by maximizing an area of the second electrode plate 113.

The separator 112 may be made of a material selected from the group consisting of polyethylene (PE), polypropylene (PP), and a composite film of PE and PP.

The separator 112 individually covers each of the first electrode plates 111. The separator 112 insulates the first electrode plate 111 from the second electrode plate 113 and the pouch 120. To this end, the separator 112 generally covers each sheet of the first electrode plates 111.

In more detail, as illustrated in FIG. 3, the separator 112, consisting of a single sheet, includes mounting regions 112a and 112b with areas corresponding to front and rear surfaces of the first electrode plate 111, and a boundary region 112c of the mounting regions 112a and 112b which surrounds a lower portion of the first electrode plate 111. In addition, the separator 112 is folded about the boundary region 112c and wraps the front and rear surfaces of the first electrode plate 111. In addition, in this state, fusing regions 112d and 112e of the separator 112 are fused to seal the first electrode plate 111. In addition, the separator 112 may expose only the first lead tab 114 protruding from the first electrode plate 111, thereby allowing the first electrode plate 111 to perform charge and discharge operations through the first lead tab 114.

Therefore, when the separator 112 covers the first electrode plate 111, it is not separately fused from the lower side of the boundary region 112c. Therefore, the overall capacity of the secondary battery 100 may be increased by increasing the area of the first electrode plate 111 when the electrode assembly 110 is formed.

As described above, since the position of the first electrode plate 111 is restricted inside the separator 112, the alignment margin of the second electrode plate 112 can be reduced, thereby increasing the capacity of the secondary battery 100.

The second electrode plate 113 may include a plurality of second electrode plates and may have a polarity opposite to that of the first electrode plate 111. For example, the second electrode plate 113 may be a positive electrode plate, and the following description will be made with regard to a case where the second electrode plate 113 is a positive electrode plate. The second electrode plate 113 may be formed by coating a second active material layer 113a, 113b, including a positive electrode active material, on a positive electrode current collector made of a metal foil to a predetermined thickness. That is to say, the second electrode plate 113 may be formed by coating the second active material layer 113a, 113b, including lithium cobalt oxide (e.g., LiCoO₂), on an aluminum foil or mesh. However, the exemplary embodiments do not limit the material of the second electrode plate 113 to that listed herein. In addition, non-coating portions, where the second active material layers 113a and 113b are not coated, are formed on opposite surfaces of the second electrode plate 113. The second lead tab 115 is integrally or separately formed at one side of the non-coating portions of the second electrode plate 113 and upwardly protrudes from the electrode assembly 110.

As described above, the second electrode plate 113 is stacked with the first electrode plate 111 and the separator 112 in an assembled state to constitute the electrode assembly 110. In addition, since movement of the first electrode plate 111 is restricted inside the separator 112, an area of the second electrode plate 113 may be maximized by minimizing an alignment margin.

In more detail, as illustrated in FIG. 4, in aligning the second electrode plate 113, the alignment margin is minimized, so that the area of the second electrode plate 113 may correspond to the first electrode plate 111 as much as possible.

In addition, since the first electrode plate 111 and the second electrode plate 113 are stacked according to the design of the secondary battery 100, the secondary battery 100 having various capacities and sizes can be manufactured.

In a state in which the first lead tab 114 is integrally or separately connected to one side of each of the non-coating portions of the first electrode plate 111 and is sequentially stacked, the first lead tab 114 upwardly protrudes from the electrode assembly 110. Meanwhile, the first lead tab 114 may have a bent portion (not shown) serving as a bending guide, so that it is bent at a predetermined position.

Here, the bent portion may be formed in various shapes and is formed at a position where the first lead tab 114 is bent. Since the first lead tab 114 is generally formed using a metal foil having a thickness of approximately 0.1 mm, it may have a weakened strength. Therefore, it is necessary to minimize the decreased strength of the first lead tab 114 by the bent portion, and the first lead tab 114 is preferably formed to have an appropriate size according to its shape.

In a state in which the second lead tab 115 is integrally or separately connected to one side of each of the non-coating portions of the second electrode plate 113 and is sequentially stacked, the second lead tab 115 upwardly protrudes from the electrode assembly 110. Meanwhile, the second lead tab 115 may also have a bent portion (not shown) serving as a bending guide, so that it is bent at a predetermined position.

In addition, the second lead tab 115 may be spaced apart from the first lead tab 114 in a direction perpendicular to a stacked direction of the electrode assembly 110. Therefore, the second lead tab 115 may be exposed to the outside of the pouch 120 independently of the first lead tab 114.

In a state in which the first electrode plate 111, the separator 112 and the second electrode plate 113 are stacked, the sealing tape 116 is applied to fix the stacked structure. The sealing tape 116 may be generally formed of polyethylene (PE), polystyrene (PS) or a composite film thereof, but aspects of the exemplary embodiments are not limited thereto. In addition, in a case where the separator 112 has adhesiveness, it can fix the first electrode plate 111 and the second electrode plate 113 in forming the electrode assembly 110, and the sealing tape 116 may not be necessarily provided.

The pouch 120 is formed of multi-layered sheets. In more detail, the pouch 120 may include a polymer sheet forming an interior surface of the pouch 120 and performing insulating and thermally fusing operations, a polyethylene terephthalate (PET) sheet forming an exterior surface of the pouch 120 and performing a protecting function, a nylon sheet or a PET-nylon composite sheet, and a metal sheet for providing mechanical strength. For brevity, the following description will be made with regard to the “nylon sheet” by way of example only. The metal sheet is interposed between the polymer sheet and the nylon sheet and may be made of, for example, an aluminum sheet.

In addition, the pouch 120 includes a first external case 121 having a top opening and accommodating the electrode assembly 110 through an internal space 121a, and a second external case 122 having a substantially planar shape and sealing the first external case 121.

Here, the second external case 122 is combined with the first external case 121 to cover the electrode assembly 110 mounted in the first external case 121.

In this state, thermal fusion is performed along edges of the first external case 121 and the second external case 122, thereby sealing the pouch 120.

In addition, the electrode assembly 110 and an electrolyte are accommodated within the pouch 120. The electrolyte includes a lithium salt, such as LiPF₆ or LiBF₄, dissolved in an organic salt, such as ethylene carbonate (EC), propylene carbonate (PC), diethyl carbonate (DEC), ethyl methyl carbonate (EMC), or dimethyl carbonate (DMC).

As described above, in the secondary battery 100 according to an exemplary embodiment, the electrode assembly 110 is formed by placing the first electrode plate 111 on a sheet of the separator 112, folding the separator 112, performing welding in a state in which the first electrode plate 111 is wrapped by the folded separator 112, and then stacking the second electrode plate 113 on the resultant structure. In such a manner, the secondary battery 100 according to an exemplary embodiment may have an increased capacity by increasing the area of the first electrode plate 111 in the separator 112 and minimizing an alignment margin of the second electrode plate 113.

Hereinafter, a configuration of a secondary battery according to another embodiment will be described.

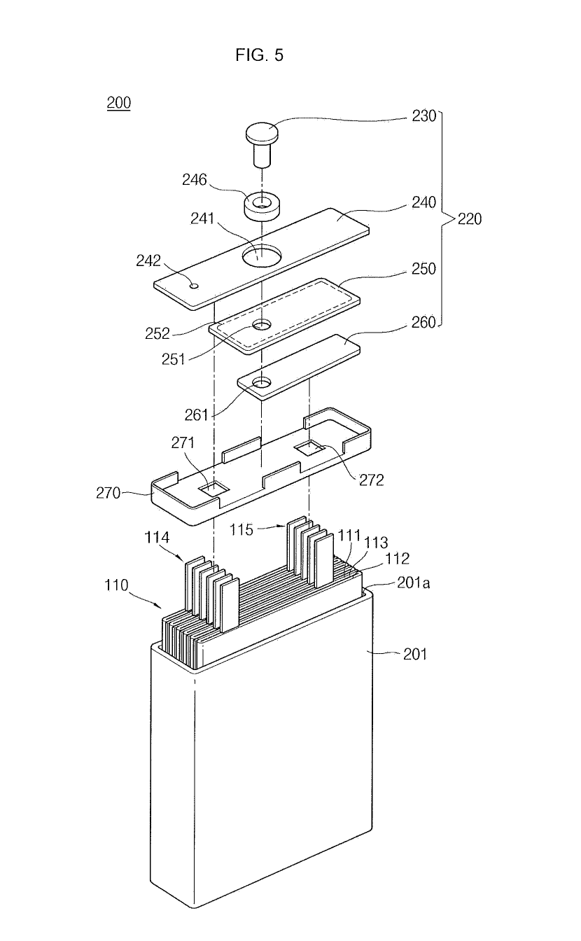

FIG. 5 is an exploded perspective view illustrating a secondary battery according to another embodiment. In the present embodiment, the element having the same configuration and the same function is denoted by the same reference numeral of the corresponding element of the previous embodiment, and the following description will focus on differences between the present and previous embodiments.

Referring to FIG. 5, the secondary battery 200 according to another embodiment may include a case 201, an electrode assembly 110 accommodated in the case 201, and a cap assembly 220 sealing a top opening 201a of the case 201.

The case 201 is made of a substantially box-shaped metal member and includes the top opening 201a formed in one surface of the case 201, and the electrode assembly 110 is accommodated through the top opening 201a. Here, the electrode assembly 110 is the same as that of the previous embodiment and a detailed description thereof will not be given.

The cap assembly 220 includes a cap plate 240, an insulating plate 250, a terminal plate 260 and an electrode terminal 230. The cap assembly 220 is coupled to the top opening 201a of the case 201 and seals the case 201.

A second lead tab 115 of the electrode assembly 110 may be welded to the cap plate 240 to then be electrically connected, and a first lead tab 114 may be welded to the terminal plate 260 to then be electrically connected.

The cap plate 240 is formed using a metal plate sized and shaped to correspond to the top opening 201a of the case 201. A first terminal throughhole 241 having a predetermined size is formed at a central portion of the cap plate 240 and an electrolyte injection hole 242 is formed at one side of the cap plate 240. The electrode terminal 230 is inserted into the first terminal throughhole 241, and a tubular gasket tube 246 is assembled on an interior surface of the first terminal throughhole 241 to insulate the electrode terminal 230 and the cap plate 240.

After the cap assembly 220 is assembled with the top opening 201a of the case 201, an electrolyte is injected through the electrolyte injection hole 242, which is then sealed by a separate closing member.

The insulating plate 250 is made of an insulating material, such as a gasket, and a mounting groove 252, in which the terminal plate 260 is mounted, is formed on a bottom surface of the insulating plate 250. A second terminal throughhole 251 is formed at a location corresponding to the first terminal throughhole 241 on one side of the insulating plate 250, and the electrode terminal 230 is inserted into the second terminal throughhole 251.

The terminal plate 260 is coupled to the mounting groove 252 of the insulating plate 250. A third terminal throughhole 261 is formed at a location corresponding to the first terminal throughhole 241 on one side of the terminal plate 260, and the electrode terminal 230 is inserted into the third terminal throughhole 261.

While the electrode terminal 230 is insulated from the terminal plate 260 by the gasket tube 246, it is inserted into terminal plate 260 through the first terminal throughhole 241, the second terminal throughhole 251 and the third terminal throughhole 261 to then be coupled thereto. Therefore, the terminal plate 260 of the cap assembly 220 is electrically connected to the electrode terminal 230 while being electrically insulated from the cap plate 240.

The insulating case 270 includes tab holes 271 and 272 to allow the first lead tab 114 and the second lead tab 115 to pass therethrough and is coupled to a bottom portion of the cap assembly 220, thereby electrically insulating the cap assembly 220 and the electrode assembly 110. The first lead tab 114 passes through the tab hole 271 to then be welded to the cap plate 240. In addition, the second lead tab 115 is welded to the terminal plate 260 through the tab hole 272.

As described above, in the secondary battery 200 according to another embodiment, the aforementioned electrode assembly 110 can be employed to manufacture a prismatic battery and can maximize the capacity of the secondary battery 200.

Hereinafter, a fabricating method of a secondary battery according to an exemplary embodiment will be described.

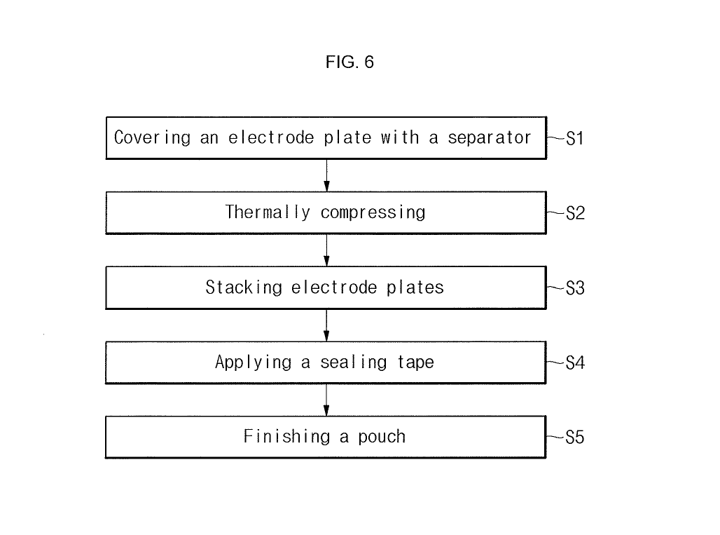

FIG. 6 is a flowchart for explaining a fabricating method of a secondary battery according to an exemplary embodiment.

Referring to FIG. 6, the fabricating method of the secondary battery 100 according to an exemplary embodiment may include covering an electrode plate with a separator (S1), thermally compressing (S2), stacking electrode plates (S3), applying a sealing tape (S4), and finishing a pouch (S5).

In covering an electrode plate with a separator (S1), as many separators 112 as the first electrode plates 111 are provided and each one of the separators 112 is placed on each of the first electrode plates 111. Here, the first electrode plate 111 may be positioned at a boundary region 112c corresponding to a roughly central portion of the separator 112.

In this state, the separator 112 is folded about the boundary region 112c, so that front and rear surfaces of the first electrode plate 111 are wrapped by the separator 112.

In thermally compressing (S2), thermal compression is performed on fusing regions 112d and 112e of the separator 112 to fuse the regions. The separator 112 is fused along outer peripheral edges of the first electrode plate 111, thereby sealing the remaining region of the first electrode plate 111, except for a region from which the first lead tab 114 protrudes.

In stacking electrode plates (S3), the second electrode plate 113 is stacked on the first electrode plate 111 wrapped by the separator 112. Here, the numbers of the first electrode plates 111 and the second electrode plate 113 stacked may correspond to each other and may vary according to the required capacity and size of the secondary battery 100.

In applying a sealing tape (S4), a sealing tape 116 is formed and applied to an outside of the first electrode plate 111, the separator 112 and the second electrode plate 113, thereby fixing the electrode assembly 110.

However, as described above, in a case where the separator 112 has adhesiveness, the sealing tape 116 may not be necessarily provided.

In finishing a pouch (S5), the electrode assembly 110 and an electrolyte are accommodated in the pouch 120, and a first pouch, such as first external case 121, and a second pouch, such as second external case 122 of the pouch 120, are fused to each other for finishing.

Accordingly, the secondary battery 100 according to an exemplary embodiment may be manufactured to include the electrode assembly 110 of a stack type.

In addition, the secondary battery 200 according to another embodiment and other types of batteries may be manufactured by the exemplary fabricating method and may include subsequent steps in addition to covering an electrode plate with a separator (S1), thermally compressing (S2) and stacking electrode plates (S3). The subsequent steps may be freely varied by one skilled in the art.

By way of summation and review, embodiments are directed to a secondary battery including an electrode assembly, which increases a capacity by increasing areas of electrode plates, and a fabricating method thereof. In this regard, a jelly-roll type electrode assembly may be suitably used for cylindrical batteries but may have several disadvantages if used for prismatic or pouch-type batteries, including active material delamination, poor space utilization efficiency, and so on.

The stack type electrode assembly is advantageous in that prismatic secondary batteries can be easily manufactured from the stack type electrode assembly. However, the manufacturing process of the stack type electrode assembly may be relatively complex, and an electrical short may be caused by electrodes pushed when impacts are applied thereto. In addition, the stack type electrode assembly should include positive and negative electrodes aligned therein.

In the secondary battery according to the embodiments disclosed, an electrode assembly is formed by placing a first electrode plate on a separator, folding the separator, performing welding in a state in which the first electrode plate is wrapped by the folded separator, and then stacking a second electrode plate on the resultant structure, thereby increasing the capacity of the secondary battery by increasing an area of the first electrode plate in the separator and minimizing an alignment margin of the second electrode plate.

Example embodiments of the secondary battery and the fabricating method thereof have been disclosed herein, and although specific terms are employed, they are used and are to be interpreted in a generic and descriptive sense only and not for purpose of limitation.

In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery including an electrode assembly, wherein the electrode assembly comprises:
at least one first electrode plate having a first polarity;
at least one separator surrounding the at least one first electrode plate; and
at least one second electrode plate stacked with respect to the first electrode plate and the separator.

2. The secondary battery as claimed in claim 1, wherein the first electrode plate is formed such that front and rear surfaces coated with active materials are wrapped by the separator.

3. The secondary battery as claimed in claim 1, wherein in a state in which the separator is folded around the first electrode plate with the first electrode plate interposed therebetween, the separator is fused along edges of the separator.

4. The secondary battery as claimed in claim 1, wherein the first electrode plate is sealed by the separator.

5. The secondary battery as claimed in claim 1, wherein the separator seals the first electrode plate, except for a first lead tab coupled to the first electrode plate.

6. The secondary battery as claimed in claim 1, wherein, in a state in which the first electrode plate, the separators and the second electrode plate are stacked, the electrode assembly further comprises a sealing tape surrounding outer peripheral edges of the electrode assembly.

7. The secondary battery as claimed in claim 1, further comprising at least one first lead tab coupled to the first electrode plate and at least one second lead tab coupled to the second electrode plate, wherein each of the at least one first lead tab is formed at a same first lead tab position and each of the at least one second lead tab is formed at a same second lead tab position to overlap each other.

8. The secondary battery as claimed in claim 7, wherein the first lead tab and the second lead tab are formed to be spaced apart from each other in a direction perpendicular to a direction in which the first electrode plate and the second electrode plate are stacked.

9. A fabricating method of a secondary battery including an electrode assembly, the fabricating method comprising:
placing a first electrode plate at a boundary region corresponding to a central portion of a separator and folding the separator around the boundary region;
fusing edges of the separator by thermal compression and sealing the first electrode plate; and
stacking a second electrode plate so as to correspond to the first electrode plate and the separator.

10. The fabricating method as claimed in claim 9, further comprising stacking the first electrode plate, the separator and the second electrode plate, and then applying a sealing tape surrounding outer peripheral edges of the electrode assembly.
